(19) United States
(12) Patent Application Publication
(10) Pub. No.: US 2016/0309684 A1
(43) Pub. Date: Oct. 27, 2016

(54) APPARATUS FOR PET HARNESS

(71) Applicant: Jarratt Lawrence SUMMERS, Edmonton (CA)

(72) Inventor: Jarratt Lawrence SUMMERS, Edmonton (CA)

(21) Appl. No.: 14/693,354

(22) Filed: Apr. 22, 2015

(51) Int. Cl. A01K 27/00; H02J 13/00; A01K 15/02

(52) U.S. Cl. CPC A01K 27/006; A01K 15/025; H02J 13/00

(57) ABSTRACT

The apparatus is for a pet harness of a pet. The apparatus includes a harness-connector assembly configured to be attached to the pet harness. The apparatus also includes a light-emitting device configured to be operatively mounted to the harness-connector assembly.

### TECHNICAL FIELD

This document relates to the technical field of (and is not limited to) an apparatus for a pet harness of a pet (and method therefor).

### BACKGROUND

A pet harness (such as, a pet collar) is piece of equipment for a pet (such as, a dog, a cat, etc.). The pet harness assists in the controlled exercise of the pet (such as, going for a walk). For instance, dog walking involves the act of a person walking with a dog, typically from the dog's residence and then returning. This constitutes part of the daily exercise regime needed to keep a dog healthy and also provides exercise and companionship for the walker.

### SUMMARY

It will be appreciated that there exists a need to mitigate (at least in part) at least one problem associated with existing pet harnesses. After much study of the known systems and methods with experimentation, an understanding of the problem and its solution has been identified and is articulated as follows.

To mitigate, at least in part, at least one problem associated with existing pet harnesses, there is provided (in accordance with a major aspect) an apparatus. The apparatus is for a pet harness of a pet. The apparatus includes a harness connector assembly configured to be attached to the pet harness. The apparatus also includes a light-emitting device configured to be operatively mounted to the harness connector assembly.

To mitigate, at least in part, at least one problem associated with existing pet harnesses, there is provided (in accordance with a major aspect) a method. The method is for operating the pet harness of the pet. The method includes (and is not limited to) an operation for operatively mounting a light-emitting device to a harness-connector assembly, and an operation for attaching a harness-connector assembly to the pet harness.

Other aspects are identified in the claims.

Other aspects and features of the non-limiting embodiments may now become apparent to those skilled in the art upon review of the following detailed description of the non-limiting embodiments with the accompanying drawings.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIGS. 1A and 1B (SHEET 1 of 6) depict side views of embodiments of an apparatus for a pet harness of a pet;

FIGS. 2A, 2B and 2C (SHEET 2 of 6) depict views of embodiments of the apparatus of any one of FIGS. 1A and 1B;

FIGS. 3A and 3B (SHEET 3 of 6) depict views of embodiments of the apparatus of any one of FIGS. 1A and 1B;

FIGS. 4A and 4B (SHEET 4 of 6) depict views of embodiments of the apparatus of any one of FIGS. 1A and 1B;

FIG. 5 (SHEET 5 of 6) depicts a perspective view of an embodiment of the apparatus of any one of FIGS. 1A and 1B; and

FIGS. 6A and 6B (SHEET 6 of 6) depict views of embodiments of the apparatus of any one of FIGS. 1A and 1B.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 apparatus
102 harness-connector assembly
104 light-emitting device
105 visible light beam
106 first clip section
107 teeth
108 second clip section
110 pivot point
112 spring assembly
114 positioning assembly
116 housing
118 circuit assembly
119 microcontroller
120 wireless device
122 battery
124 power button
126 light source
128 speaker
130 vibrating device
132 hand-held wireless control device
134 hand held wireless remote control unit
900 pet harness
902 pet

### DETAILED DESCRIPTION OF THE EXEMPLARY EMBODIMENTS

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

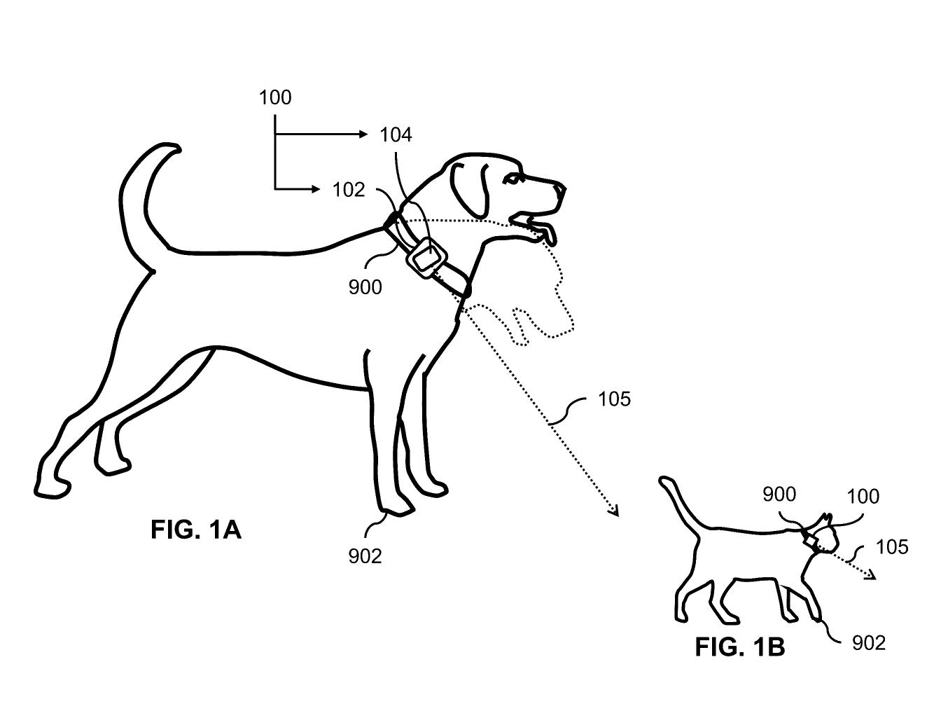

FIGS. 1A and 1B depict side view of embodiments of an apparatus 100 for a pet harness 900 of a pet 902.

It will be appreciated that the apparatus 100 does not include the pet harness 900 and the pet 902. The pet 902 may include a dog (as depicted in FIG. 1A) or a cat (as depicted in FIG. 1B). The user (pet owner) mounts the apparatus 100 to the pet harness 900.

The apparatus 100 includes (and is not limited to) a synergistic combination of a harness-connector assembly 102 and a light-emitting device 104. The harness-connector assembly 102 is configured to be attached (either directly or indirectly) to the pet harness 900. The light-emitting device 104 is configured to be operatively mounted (directly or indirectly) to the harness-connector assembly 102.

Advantageously, the apparatus 100 provides an opportunity to aid (assist) in the exercising of the pet 902 and/or in the training of the pet 902.

In accordance with an embodiment, there is a method for operating the pet harness 900 of the pet 902. The method includes (and is not limited to) an operation for operatively mounting a light-emitting device 104 to a harness-connector assembly 102, and an operation for attaching a harness-connector assembly 102 to the pet harness 900.

In accordance with a preferred embodiment, the pet harness 900 includes any one of a dog collar for a dog and a cat collar for a cat.

The light-emitting device 104 includes any suitable light source (flashlight, etc.) configured to emit a visible light beam 105. In accordance with a preferred embodiment, the light-emitting device 104 includes a laser device and any equivalent thereof. The laser device is configured to emit light through a process of optical amplification based on the stimulated emission of electromagnetic radiation. Laser is as an acronym for light amplification by stimulated emission of radiation. The laser device is configured to emit light (a laser light) coherently in such a way that the laser light is focused to a relatively tight spot.

For the case where the pet owner energizes the light-emitting device 104 (to turn the light-emitting device 104 on), the pet 902 can then respond to the visible light beam 105 emitted by the light-emitting device 104.

In accordance with a preferred option, the light-emitting device 104 is configured to be controlled in such a way that the visible light beam 105 that is emitted can be aligned along a user-selected path of choice. For instance, the pet 902 may follow the light beam 105 by walking along a straight line and/or may chase the visible light beam 105 along any path, depending on the control settings of the light-emitting device 104 (as set or selected by the user of the apparatus 100).

In accordance with a preferred embodiment, the harness-connector assembly 102 is configured to be mounted to a side portion of the pet harness 900 positioned to a lateral side of the pet 902 (as depicted in FIGS. 1A and 1B). Alternatively, the harness-connector assembly 102 is configured to be mounted to a lower portion of the pet harness 900 located underneath the chin (of the head) of the pet 902. It will be appreciated that for the case where the pet 902 has a relatively longer face, the chin of the pet 902 may block transmission of the visible light beam 105 from the light-emitting device 104.

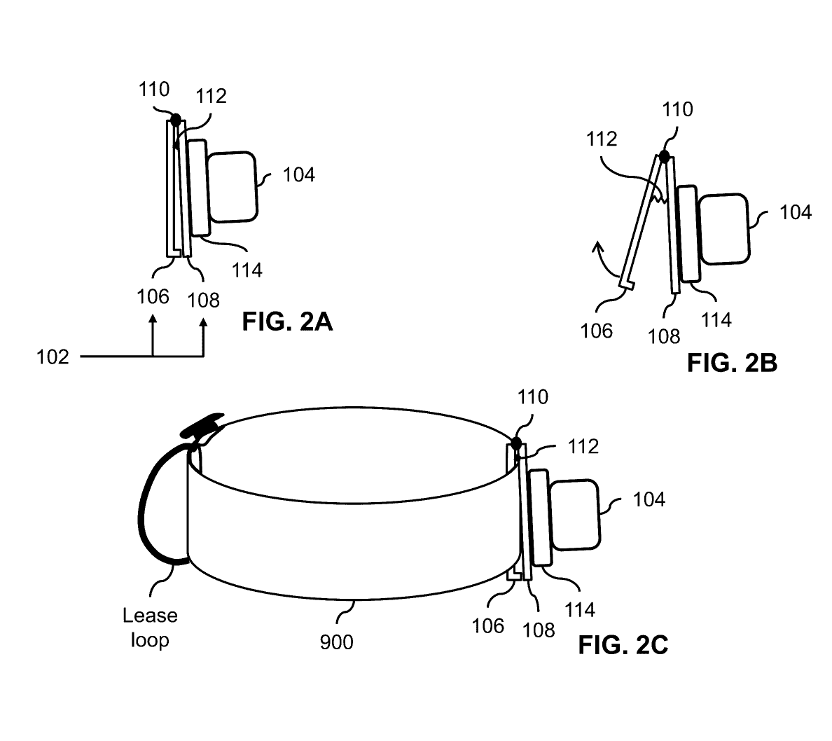

FIGS. 2A, 2B and 2C depict views of embodiments of the apparatus 100 of any one of FIGS. 1A and 1B. FIGS. 2A and 2B depict side views of the apparatus 100. FIG. 2C depicts a perspective view of the apparatus 100.

In accordance with the embodiments depicted in FIGS. 2A, 2B and 2C, the harness-connector assembly 102 includes a first clip section 106 and a second clip section 108. The second clip section 108 is pivotally connected to the first clip section 106 at a pivot point 110.

A spring assembly 112 is positioned between the first clip section 106 and the second clip section 108 at a position proximate to the pivot point 110. The spring assembly 112 is configured to normally urge the first clip section 106 and the second clip section 108 together (toward the closed condition or the closed position (as depicted in FIG. 2A). The first clip section 106 and the second clip section 108 are urged to close against each other (by way of the operation of the spring assembly 112) similar to a the operation of a clamping device.

Referring to FIG. 2B, the user manually preys open the mouth section of the harness-connector assembly 102 (at the open end thereof) to urge the first clip section 106 and the second section into the open state. This is done so that the harness-connector assembly 102 may be positioned to and connected with the pet harness 900 (as depicted in FIG. 2C).

The apparatus 100 further includes a positioning assembly 114 positioned between the harness-connector assembly 102 and the light-emitting device 104. The positioning assembly 114 is configured to adjust the spatial orientation of the light-emitting device 104 relative to the harness-connector assembly 102 (such as, rotationally adjust the spatial orientation). An example of the positioning assembly 114 is described in U.S. Pat. No. 8,333,310 or is described in United States Patent Number US 2013/0126565 (both incorporated herein by reference).

The positioning assembly 114 is configured to facilitate angled orientation of the light-emitting device 104 relative to the harness-connector assembly 102 (to suit pet and harness situations or geometry).

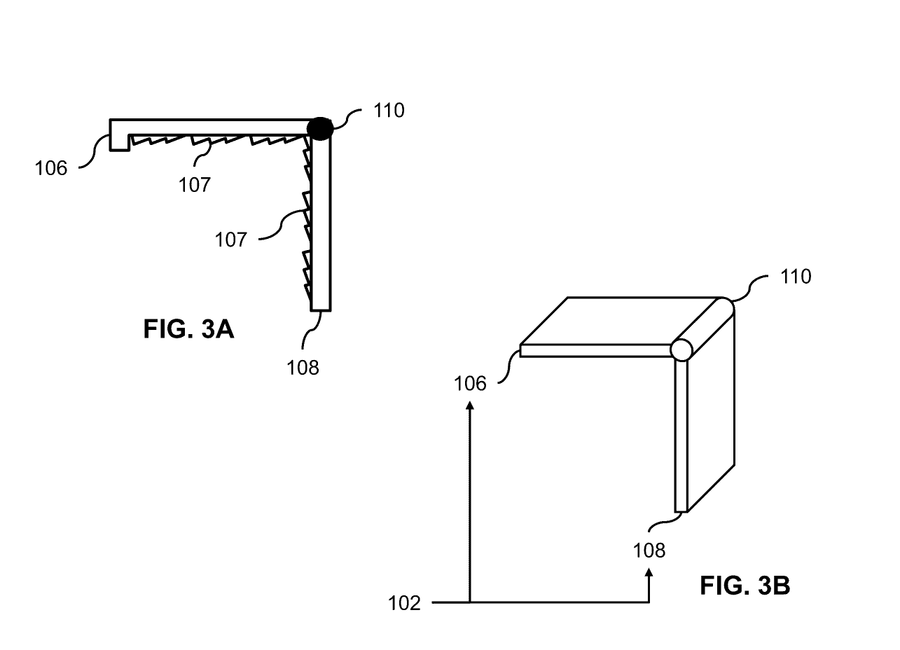

FIGS. 3A and 3B depict views of embodiments of the apparatus 100 of any one of FIGS. 1A and 1B. FIG. 3A depicts a side view of the harness-connector assembly 102. FIG. 3B depicts a perspective view of the harness-connector assembly 102.

In accordance with the embodiments depicted in FIGS. 3A and 3B, the harness-connector assembly 102 includes teeth 107 installed on the inside portion of the first clip section 106 and on the inside position of the second clip section 108. This is done in such a manner that the teeth 107 make contact with the pet harness 900 depicted in FIG. 2C (in the closed condition or position of the harness-connector assembly 102).

FIG. 3B depicts the harness-connector assembly 102 without the teeth depicted in FIG. 3A. The first clip section 106 and the second clip section 108 include pivotally mounted planar sections configured to move between the closed condition (position) and the open condition (position) as depicted in FIGS. 2A and 2B, respectively.

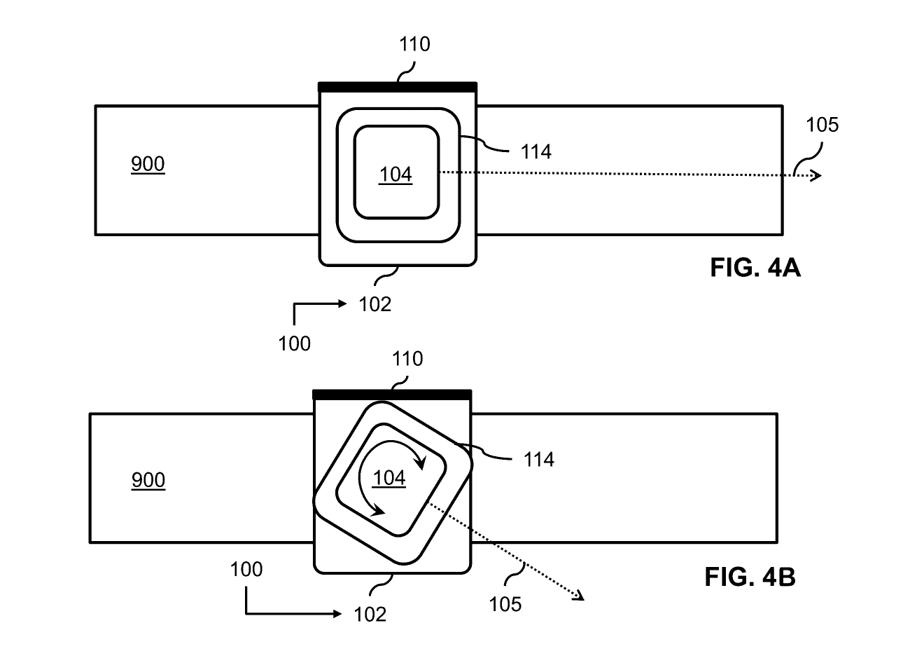

FIGS. 4A and 4B depict views of embodiments of the apparatus 100 of any one of FIGS. 1A and 1B. FIG. 4A and FIG. 4B depict side views of the apparatus 100.

Referring to the embodiment depicted in FIG. 4A, the positioning assembly 114 is configured to position (orient or align) the light-emitting device 104 in such a way that the visible light beam 105 is emitted from the assembly along a longitudinal axis extending along the pet harness 900. Referring to the embodiment depicted in FIG. 4B, the positioning assembly 114 is configured to position (orient or align) the light-emitting device 104 in such a way that the visible light beam 105 is emitted from the assembly along a direction that is off axis from the longitudinal axis extending along the pet harness 900. The positioning assembly 114 is configured to position (orient or align) the light-emitting device 104 in such a way that the angular orientation of the light-emitting device 104 may be set to a desired position so that the visible light beam 105 may be emitted in a desired direction.

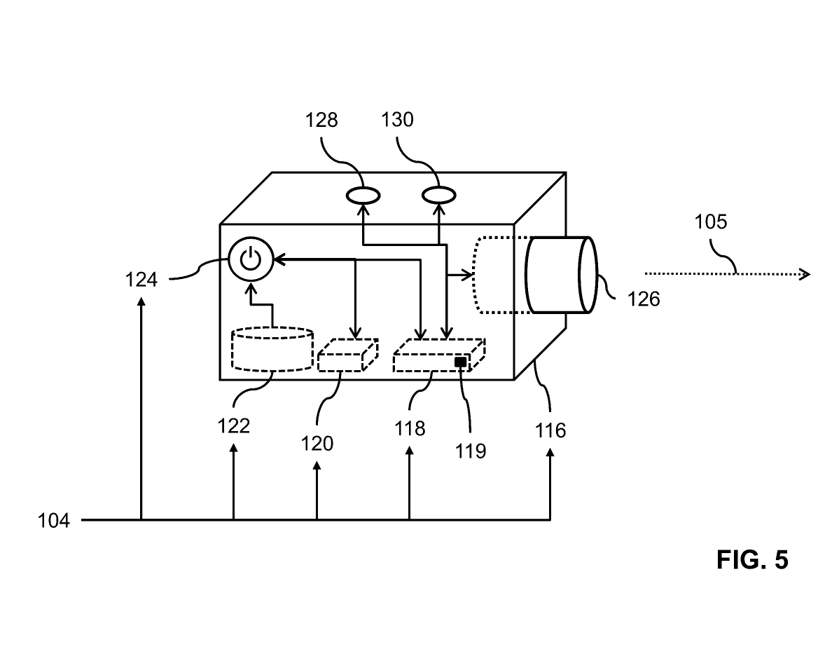

FIG. 5 depicts a perspective view of the embodiment of the apparatus 100 of any one of FIGS. 1A and 1B. FIG. 5 depicts a schematic representation of the light-emitting device 104.

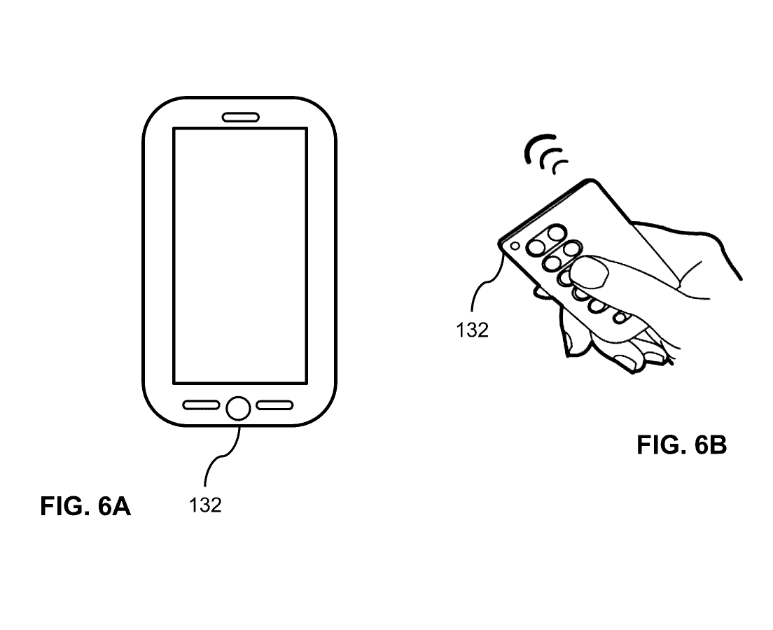

In accordance with the embodiment depicted in FIG. 5, the light-emitting device 104 includes a housing 116. A circuit assembly 118 is mounted inside the housing 116. A wireless device 120 (optional) is mounted inside the housing 116. A battery 122 (such as a disk battery) is mounted inside the housing 116. A power button 124 is mounted to the housing 116. The power button 124 is configured to provide power from the battery 122 to the components contained in the housing 116. A light source 126 (such as a laser light source) is mounted to the housing 116. The circuit assembly 118 is configured to control operation of the light source 126. The circuit assembly 118 is connected to the wireless device 120. User control of the circuit assembly 118 may be performed wirelessly, via the wireless device 120, by a hand-held wireless control device 132 (depicted in any one of FIGS. 6A and 6B).

In accordance with a preferred embodiment, the light-emitting device 104 further includes a speaker 128 mounted to the housing 116 and is connected to the circuit assembly 118. The speaker 128 is configured to emit an audible noise when the light-emitting device 104 emits the visible light beam 105. The pet may become accustomed to hearing the audible noise when the visible light beam 105 is emitted by the light-emitting device 104. In this manner, the pet owner may decide to control the speaker 128 (for the amusement of the pet).

In accordance with a preferred embodiment, the light-emitting device 104 further includes a vibrating device 130 mounted to the housing 116, and is connected to the circuit assembly 118. The vibrating device 130 is configured to vibrate the housing 116 when the light-emitting device 104 emits the visible light beam 105. The pet may become accustomed to tactically sensing the vibration when the visible light beam 105 is emitted by the light-emitting device 104. In this manner, the pet owner may decide to control the vibrating device 130 (for the amusement of the pet).

In accordance with a preferred embodiment, the circuit assembly 118 includes a microcontroller 119, which is a relatively smaller computer mounted on a single integrated circuit having a processor core, memory, and programmable input and output peripherals. The microcontroller 119 includes program memory in the form of ferroelectric RAM (random access memory), NOR flash memory, and/or OTP ROM (one-time programmable read only memory). NOR flash memory is a type of non-volatile storage technology that does not require power to retain data. The microcontroller 119 is configured to be embedded (placed) in the light-emitting device 104. The microcontroller 119 is configured to control operations of the light-emitting device 104 (that is, to assist the user in the control of the light-emitting device 104). The microcontroller 119 provides an economical approach to digital control of the light-emitting device 104. The microcontroller 119 may be configured to integrate analog components for the control of non-digital electronic devices. The microcontroller 119 may use four-bit words and operate at clock rate frequencies as low as about four kiloHertz (kHz), for relatively lower power consumption. The microcontroller 119 is configured to retain functionality while waiting for an event such as a button press or other interrupt. Power consumption of the microcontroller 119 while the microcontroller 119 is not used is relatively low (for longer lasting operation of the battery 122). The microcontroller 119 is operatively coupled to a memory unit (known and not depicted) that tangibly stores a microcontroller-executable program (also called software) that is configured to urge (instruct) the microcontroller to execute operations (as described in the written description).

FIGS. 6A and 6B depict views of embodiments of the apparatus 100 of any one of FIGS. 1A and 1B.

FIG. 6A depicts a front view of the hand-held wireless control device 132 (smart phone) configured to control the light-emitting device 104 of FIG. 5. FIG. 6B depicts a perspective view of a hand held wireless remote control unit 134 (an electronic FOB) configured to control the light-emitting device 104 of FIG. 5. The hand-held wireless control device 132 includes an electronic circuit configured to control the light-emitting device 104 (depicted in FIG. 5) in a wireless mode of operation, and includes an on/off control button, etc. The hand-held wireless control device 132 is configured to shut down the light-emitting device 104 prior to the light-emitting device 104 going out of range (for the case where the pet attempts to travel further than the wireless control capability of the hand-held wireless control device 132 and the light-emitting device 104 (as a fail-safe option). For instance, the range of control may be from about 20 feet to about 30 feet. The word FOB is believed to have originated from a watch FOB that existed as early as 1888 in which the watch FOB referred to an ornament attached to a pocket-watch chain. The electronic FOB is an attachment that may be connected to a key chain (for instance).

This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It may be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. An apparatus for a pet harness of a pet, the apparatus comprising:
a harness-connector assembly being configured to be attached to the pet harness; and
a light-emitting device being configured to be operatively mounted to the harness-connector assembly.

2. The apparatus of claim 1, wherein:
the pet harness includes any one of a dog collar for a dog and a cat collar for a cat.

3. The apparatus of claim 1, wherein:
the light-emitting device includes
a laser device.

4. The apparatus of claim 1, wherein:
the harness-connector assembly is configured to be any one of (A) mounted to a side portion of the pet harness positioned to a lateral side of the pet and (B) a lower portion of the pet harness located underneath the chin of the pet.

5. The apparatus of claim 1, wherein:
the harness-connector assembly includes:
a first clip section; and
a second clip section being pivotally connected to the first clip section at a pivot point.

6. The apparatus of claim 5, wherein:
the harness-connector assembly further includes:
a spring assembly being positioned between the first clip section and the second clip section at a position proximate to the pivot point; and
the spring assembly being configured to normally urge the first clip section and the second clip section together toward a closed condition.

7. The apparatus of claim 6, wherein:
the spring assembly is operable in such a way that the user manually preys open a mouth section of the harness-connector assembly at the open end thereof to urge the first clip section and the second section into the open state so that the harness-connector assembly is positionable to and connectable with the pet harness.

8. The apparatus of claim 5, further comprising:
the harness-connector assembly includes:
teeth installed on the inside portion of the first clip section and on the inside position of the second clip section in such a way that the teeth make contact with the pet harness in the closed condition of the harness-connector assembly.

9. The apparatus of claim 1, further comprising:
a positioning assembly being positioned between the harness-connector assembly and the light-emitting device; and
the positioning assembly being configured to adjust the spatial orientation of the light-emitting device relative to the harness-connector assembly.

10. The apparatus of claim 8, further comprising:
the positioning assembly is configured to facilitate angled orientation of the light-emitting device relative to the harness-connector assembly.

11. The apparatus of claim 8, further comprising:
the positioning assembly is configured to position the light-emitting device in such a way that the visible light beam is emitted from the assembly along a longitudinal axis extending along the pet harness; and
the positioning assembly is configured to position the light-emitting device in such a way that the visible light beam is emitted from the assembly along a direction that is off axis from the longitudinal axis extending along the pet harness.

12. The apparatus of claim 8, further comprising:
the positioning assembly is configured to position the light-emitting device in such a way that the angular orientation of the light-emitting device is set to a desired position in such a way that the visible light beam is emitted in a desired direction.

13. The apparatus of claim 8, wherein:
the light-emitting device includes:
a housing;
a circuit assembly being mounted inside the housing;
a battery being mounted inside the housing;
a power button being mounted to the housing, and the power button being configured to provide power from the battery to the components contained in the housing; and
a light source being mounted to the housing, and the circuit assembly being configured to control operation of the light source.

14. The apparatus of claim 13, further comprising:
a wireless device being mounted inside the housing; and
wherein the circuit assembly is connected to the wireless device, and user control of the circuit assembly is performed wirelessly, via the wireless device, by a hand-held wireless control device.

15. The apparatus of claim 13, further comprising:
a speaker being mounted to the housing and also being connected to the circuit assembly;
the speaker being configured to emit an audible noise when the light-emitting device emits the visible light beam.

16. The apparatus of claim 13, further comprising:
a vibrating device mounted to the housing, and is connected to the circuit assembly. The vibrating device is configured to vibrate the housing when the light-emitting device emits the visible light beam. The pet may become accustomed to tactically sensing the vibration when the visible light beam is emitted by the light-emitting device. In this manner, the pet owner may decide to control the vibrating device (for the amusement of the pet).

17. The apparatus of claim 13, further comprising:
the circuit assembly includes a microcontroller being configured to control operation of the light-emitting device.

18. The apparatus of claim 13, further comprising:
the circuit assembly being configured to control operation of the light-emitting device.

19. The apparatus of claim 14, wherein:
the hand-held wireless control device includes any one of a smart phone and an electronic FOB.

20. A method of operating a pet harness of a pet, the method comprising:
operatively mounting a light-emitting device to a harness-connector assembly; and
attaching a harness-connector assembly to the pet harness.
